(19) United States
(12) Patent Application Publication
(10) Pub. No.: US 2008/0192035 A1
(43) Pub. Date: Aug. 14, 2008

(54) Liquid crystal display having an initialization IC and driving method thereof

(75) Inventors: Sai-Xin Guan, Shenzhen (CN); Yi-Yin Chen, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignees: INNOCOM TECHNOLOGY (SHENZHEN) CO., LTD.; INNOLUX DISPLAY CORP.

(21) Appl. No.: 12/069,883

(22) Filed: Feb. 12, 2008

(30) Foreign Application Priority Data
Feb. 12, 2007 (TW) 96104974

(51) Int. Cl. G06F 3/038; G09G 3/36

(52) U.S. Cl. 345/204; 345/87

(57) ABSTRACT

An exemplary liquid crystal display (200) includes an LCD panel (210), a driving integrated circuit (IC) (220) provided with the LCD panel and configured for driving the LCD panel to display image, and an initialization IC (240) provided with the LCD panel and configured for initializing the driving IC at each time that the LCD is turned on. In a test of the LCD panel to detect whether there are any abnormalities, the driving IC mounted on the LCD panel can be initialized by the initialization IC.

### FIELD OF THE INVENTION

The present invention relates to liquid crystal displays (LCDs) and methods for driving LCDs, and more particularly to an LCD including an initialization integrated circuit (IC) that is configured to initialize a driving IC of the LCD.

### GENERAL BACKGROUND

Because LCDs have the advantages of portability, low power consumption, and low radiation, they have been widely used in various portable information products such as notebooks, personal digital assistants (PDAs), video cameras, and the like. Furthermore, LCDs are considered by many to have the potential to completely replace CRT (cathode ray tube) monitors and televisions.

Referring to FIG. 2, a conventional LCD 100 includes an LCD panel 110, a driving integrated circuit (IC) 120 attached on the LCD panel 110 by a chip on glass (COG) method, and a printed circuit board (PCB) 130. The PCB 130 includes a controlling IC 132. The PCB 130 is configured to provide operating voltages and image signals to the driving IC 120. The driving IC 120 is configured to drive the LCD panel 110 to display images according to the image signals.

The controlling IC 132 is configured to execute various functions of the LCD 100. For example, the controlling IC 132 can control a normal serial bus of the LCD 100. When the LCD 100 is turned on, the controlling IC 132 provides initialization data to the driving IC 120 for initializing the driving IC 120. Typically, the initialization data are provided in the form of a serial data signal. Thereupon the driving IC 120 can work normally and drive the LCD panel 110.

In a normal process of manufacturing the LCD 100, a test is performed to detect whether or not there are any abnormalities on the LCD panel 110 after the driving IC 120 is mounted on the LCD panel 110. Even though the driving IC 120 is mounted on the LCD panel 110 in a later stage in the process of the manufacturing the LCD 100, other manufacturing steps still remain to be performed. Therefore when the detection test is performed, the driving IC 120 mounted on the LCD panel 110 has not yet been initialized. Thus an external circuit is needed to initialize the driving IC 120, so that the LCD panel 110 can display images during the test. Thus, the test process is somewhat complicated.

It is desired to provide an LCD which overcomes the above-described deficiencies.

### SUMMARY

In one preferred embodiment, an LCD includes an LCD panel, a driving IC provided with the LCD panel for driving the LCD panel to display image, and an initialization IC provided with the LCD panel for initializing the driving IC at each time that the LCD is turned on.

Other novel features and advantages of the above-described LCDs will become more apparent from the following detailed description when taken in conjunction with the accompanying drawings, in which:

### BRIEF DESCRIPTION OF THE DRAWINGS

FIG. 1 is a block diagram of an LCD according to an exemplary embodiment of the present invention; and

FIG. 2 is a block diagram of a conventional LCD.

### DETAILED DESCRIPTION OF PREFERRED EMBODIMENTS

Reference will now be made to the drawings to describe the present invention in detail.

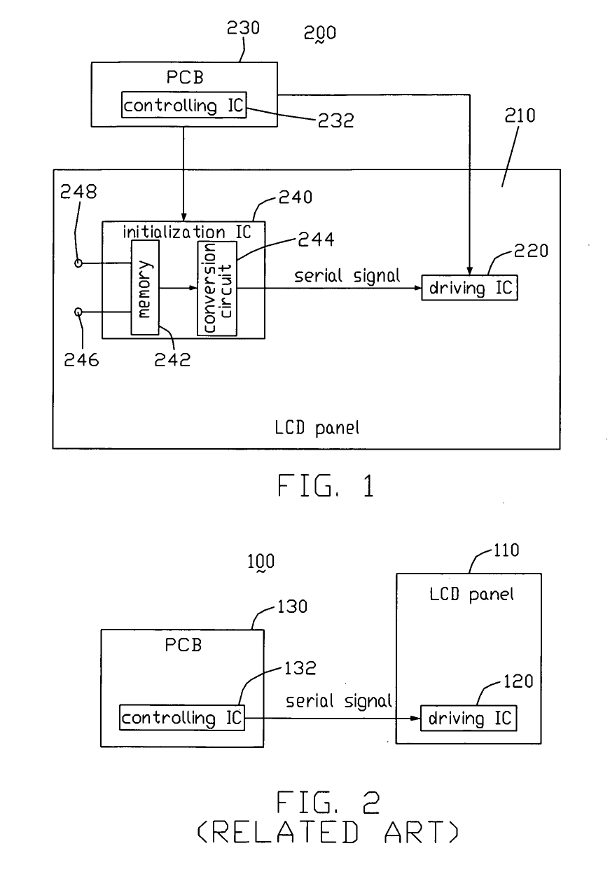

Referring to FIG. 1, an LCD 200 according to an exemplary embodiment of the present invention is shown. The LCD 200 includes an LCD panel 210, a driving IC 220 attached on the LCD panel 210 by a COG method, a PCB 230, and an initialization IC 240 arranged on the LCD panel 210. The driving IC 220 is configured to drive the LCD panel 210 to display images.

The PCB 230 includes a controlling IC 232. The PCB 230 is configured to provide operating voltages and image signals to the driving IC 220. The controlling IC 232 is configured to execute various functions of the LCD 200. For example, the controlling IC 232 can control a normal serial bus of the LCD 200.

The initialization IC 240 is configured for initializing the driving IC 220 when the LCD 200 is turned on. The initialization IC 240 includes a memory 242 and a conversion circuit 244. The memory 242 is configured to store initialization data of the driving IC 220. When the LCD 200 is turned on, the memory 242 transmits the initialization data to the conversion circuit 244. The conversion circuit 244 is configured to transform the initialization data into a serial data signal, and provide the serial data signal to the driving IC 220 via a serial bus. Thereupon the driving IC 220 can work normally and drive the LCD panel 110.

The memory 242 includes a voltage input 246 and a data input 248. The voltage input 246 is configured to receive an operating voltage of the memory 242. The data input 248 is configured to receive the initialization data of the LCD 200 from a programmer (not shown). The initialization data can be serial data or parallel data.

Typical operation of the LCD 200 is as follows. When the LCD 200 is turned on, the operation voltage is provided to the voltage input 246 of the memory 242 from an external power supply (not shown). Thus the memory 242 provides the initialization data to the conversion circuit 244. The conversion circuit 244 transforms the initialization data into a serial data signal, and provides the serial data signal to the driving IC 220. The driving IC 220 is initialized by the serial data signal so as to drive the LCD panel 210 to display images.

Because the LCD 200 includes the initialization IC 240, the driving IC 220 of the LCD 200 can be initilized when the LCD 200 is turned on. In a test of the LCD panel 210 for detecting whether or not there are any abnormalities, the driving IC 220 mounted on the LCD panel 210 can be initialized by the initialization IC 240. Therefore unlike in conventional art, there is no need for an external circuit for initializing the driving IC 220 and testing the LCD panel 210. Thus the process of testing the LCD 200 is simplified.

In a further alternative embodiment, image data for the test process can also be written into the memory 242 via the data input 248.

Those skilled in the art will readily appreciate that numerous modifications and alterations of the above-described LCD and method may be made without departing from the scope of the principles of the present invention. Accordingly, the above disclosure should be construed as limited only by the metes and bounds of the appended claims or equivalents thereof.

What is claimed is:

1. A liquid crystal display (LCD) comprising:
an LCD panel;
a driving integrated circuit (IC) provided with the LCD panel and configured for driving the LCD panel to display images; and
an initialization IC provided with the LCD panel and configured for initializing the driving IC when the LCD is turned on.

2. The liquid crystal display as claimed in claim 1, wherein the initialization IC comprises a memory and a conversion circuit, the memory being configured for storing initialization data of the driving IC and transmitting the initialization data to the conversion circuit when the LCD is turned on, the conversion circuit being configured for transforming the initialization data into a serial data signal and providing the serial data signal to the driving IC.

3. The liquid crystal display as claimed in claim 2, wherein the memory comprises a voltage input, the voltage input being configured for receiving an operating voltage of the memory.

4. The liquid crystal display as claimed in claim 3, wherein the memory further comprises a data input, the data input being configured for receiving the initialization data.

5. The liquid crystal display as claimed in claim 4, wherein the initialization data are serial data.

6. The liquid crystal display as claimed in claim 4, wherein the initialization data are parallel data.

7. The liquid crystal display as claimed in claim 1, further comprising a printed circuit board (PCB), the PCB being configured for providing operating voltages to the driving IC and the initialization IC.

8. A method for driving a liquid crystal display (LCD), the method comprising:
providing an LCD, the LCD comprising an LCD panel, a driving integrated circuit (IC) provided with the LCD panel, and an initialization IC provided with the LCD panel,
providing an operating voltage to the initialization IC in order to initialize the driving IC when the LCD is turned on, and
the driving IC driving the LCD panel of the LCD to display images.

9. The method as claimed in claim 8, wherein the initialization IC comprises a memory and a conversion circuit, the memory being configured for storing initialization data of the driving IC and transmitting the initialization data to the conversion circuit when the LCD is turned on, the conversion circuit being configured for transforming the initialization data into a serial data signal and providing the serial data signal to the driving IC.

10. The method as claimed in claim 9, wherein the memory comprises a voltage input, the voltage input being configured for receiving an operating voltage.

11. The method as claimed in claim 10, wherein the memory further comprises a data input, the data input being configured for receiving the initialization data.
